(19) United States
(12) Patent Application Publication
(10) Pub. No.: US 2010/0042547 A1
(43) Pub. Date: Feb. 18, 2010

(54) METHODS AND SYSTEMS FOR MONEY TRANSFER WITH CABLE AND/OR SATELLITE PROVIDERS

(75) Inventors: Ernest Armenta, Tucson, AZ (US); Gail Galuppo, Lone Tree, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The Western Union Company, Englewood, CO (US)

(21) Appl. No.: 12/189,950

(22) Filed: Aug. 12, 2008

(51) Int. Cl. H04L 9/00; G06Q 40/00

(52) U.S. Cl. 705/72; 705/42

(57) ABSTRACT

The invention provides various systems and methods for providing money transfers executed in connection with cable and/or satellite providers. The method includes presenting an interface to a user on a service provider's signal receiving device. The interface includes money transfer options. The method further includes receiving a money transfer initiation request from the user, and verifying the user's identity. The method then forwards the money transfer initiation request to a money transfer provider, and generates a money transfer control number associated with the money transfer initiation request. Furthermore, the method includes activating the money transfer control number, and transmitting the money transfer control number to a recipient.

### FIELD OF THE INVENTION

The present invention relates, in general, to financial transactions, and more particularly, to money transfers executed in connection with cable and/or satellite providers.

### BACKGROUND OF THE INVENTION

Presently, in order for a money transfer to be initiated and executed a customer is required to physically enter into an agent location of a money transfer provider and setup the money transfer. This can be incontinent, expensive and time consuming. The money transfer provider may lose business and revenue because some customers or potential customers are unwilling or unable to physically make a trip to an agent location. Accordingly, improvements in the art are needed.

### BRIEF SUMMARY OF THE INVENTION

The present invention provides a method of providing money transfers executed in connection with cable and/or satellite providers. The method includes presenting an interface to a user on a service provider's signal receiving device. The interface includes money transfer options. The method further includes receiving a money transfer initiation request from the user, and verifying the user's identity. The method then forwards the money transfer initiation request to a money transfer provider, and generates a money transfer control number associated with the money transfer initiation request. Furthermore, the method includes activating the money transfer control number, and transmitting the money transfer control number to a recipient.

An alternative embodiment provides a system for providing money transfers executed in connection with cable and/or satellite providers. The system includes a set top box configured to present an interface to a user on a service provider's signal receiving device. The interface includes money transfer options. The set top box is further to receive a money transfer initiation request from the user. In one embodiment, the initiation request may be initially performed at the time that the user subscribes to the money transfer service via the cable/satellite provider. Accordingly, after this one-time registration process, the user is free to initiate money transfers and other such similar activities without re-registering. The system further includes a television provider coupled with the set top box configured to verify the user's identity and to forward the money transfer initiation request to a money transfer provider. The system also includes a money transfer provider coupled with the television provider configured to generate a money transfer control number associated with the money transfer initiation request, to activate the money transfer control number, and to transmit the money transfer control number to a recipient.

A further embodiment of the present invention provides a machine-readable medium for providing money transfers executed in connection with cable and/or satellite providers. The machine-readable medium includes instructions for presenting an interface to a user on a service provider's signal receiving device. The interface includes money transfer options. The machine-readable medium further includes instructions for receiving a money transfer initiation request from the user and verifying the user's identity. The machine-readable medium then includes instructions for forwarding the money transfer initiation request to a money transfer provider and generating a money transfer control number associated with the money transfer initiation request. Furthermore, the machine-readable medium includes instructions for activating the money transfer control number, and transmitting the money transfer control number to a recipient.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral to denote one of multiple similar components. When reference is made to a reference numeral without specification to an existing sublabel, it is intended to refer to all such multiple similar components.

FIG. 1 is a flow diagram illustrating a method of providing money transfers executed in connection with cable and/or satellite providers, according to one embodiment of the present invention.

FIG. 2 is a block diagram illustrating a system for providing money transfers executed in connection with cable and/or satellite providers, according to one embodiment of the present invention.

FIG. 3 is a generalized schematic diagram illustrating a computer system, in accordance with various embodiments of the invention.

FIG. 4 is a block diagram illustrating a networked system of computers, which can be used in accordance with various embodiments of the invention.

### DETAILED DESCRIPTION OF THE INVENTION

The invention provides various systems and methods for money transfers executed in connection with cable and/or satellite providers. In order to provide more continence and accessibility of money transfer services to customers, the aspects of the present invention provides for integration of such services into cable and satellite provider set top boxes, as well as with other electronic devices.

For example, a customer may be viewing a television program and realize that they needed to transfer money to their son or daughter at school across the country. Instead of going to an agent location (e.g., a Western Union® agent), and initiating the money transfer, the customer can simply use their cable provider's remote (or similar device) to access an interface and initiate the money transfer. Accordingly, with little or no interruption to the customers' schedule, the money transfer can be executed with ease.

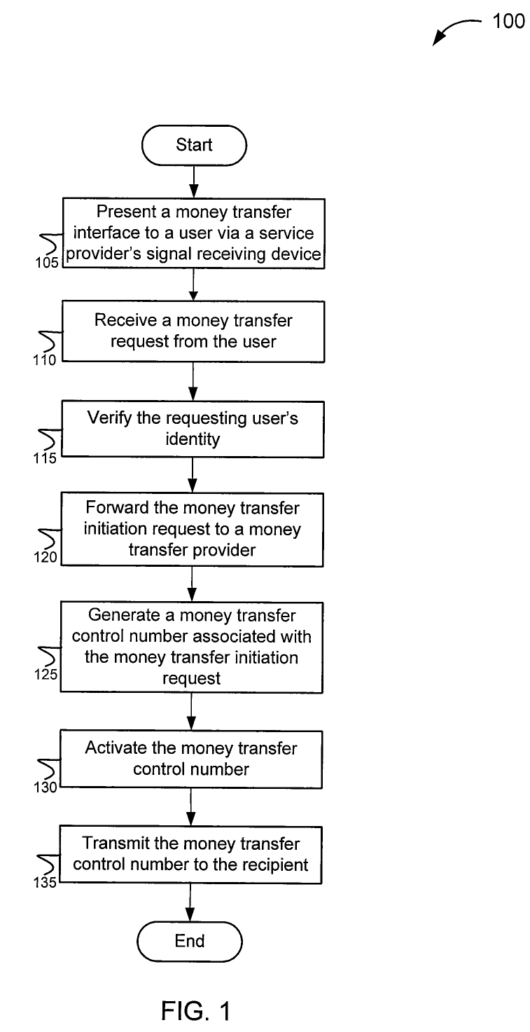

Turning now to FIG. 1, which illustrates a method 100 of providing money transfers executed in connection with cable and/or satellite providers, according to one embodiment of the present invention. In an alternative embodiment, additional forms of currency may be transferred using the systems and methods described in the present invention. For example, airline miles, rewards points, coupons, rebates, etc. may be transferred and/or received in connection with the cable/satellite providers, as described below in the context of money transfers. At process block 105, a money transfer interface may be presented to a user. In one embodiment, the interface may be presented using a signal receiving device from a service provider. The signal receiving device may be, for example, a digital video recorder (DVR), set top box, or other similar device. Furthermore, the service provider may be a cable or satellite television service provider. Alternatively, the service provider may be a gaming account service provider, an automobile hazard assistance provider, a satellite radio provider, etc.

In an alternative embodiment, the signal receiving device may be a gaming console with an Internet or similar network connection. Alternatively, the signal receiving device may be a satellite radio device, a hotel television ordering device, personal digital assistant (PDA), a mobile device, a global positioning system (GPS) device, etc. Furthermore, the signal receiving device may be a device embedded in an automobile, for example, a service connected device, a navigation display device, a Bluetooth enabled device, etc. Accordingly, the signal receiving device may be any device which allows a user to be presented with options configured to allow for initiation of a money transfer or similar financial transaction.

In a further embodiment, the interface may be embedded within the set top box's menu system. For example, a tab or menu option may be included which allows the user to initiate money transfer services. The user may utilize a remote control or other similar device to highlight the money transfer menu option and subsequently select the option. The remote may also have a money transfer initiation button built into the remote control. After selecting the option, the user may then be presented with a number of money transfer actions available to the user. In one embodiment, the user may be presented with a list of previous money transfer recipients, or may be presented with an option of adding and/or removing recipients from being displayed.

The user may then initiate a money transfer to one or more of the recipients in the list of recipients. At process block 110, a money transfer initiation request may be received by, for example, the cable provider. However, other service providers may receive the request depending on the signal receiving device being used by the user. Nonetheless, for purposes of explanation, reference to a set top box and a cable provider will be used.

At process block 115, the user's identity may be verified. For example, the user may have been directed to select a personal identification number (PIN), password, or the like during a setup or registration process with their cable provider. Accordingly, the user's PIN is stored within, for example, a customer profile within a customer database. Hence, in order to verify the user's identity, the user is prompted to enter the PIN into the set top box, and then the entered PIN is checked against the PIN stored in the customer database. Therefore, if the PINs match, then the user is verified; however, if the PINs do not match, then no verification occurs. In a further embodiment, the customer database may include personal information (e.g., the customer's name, address, telephone number(s), credit card and banking information, etc.), which may be used by the money transfer provider for user identification purposes and/or payment purposes.

At process block 120, upon successful verification of the user's identity, the money transfer request may be forwarded (or transmitted) to the money transfer provider. The money transfer request may include the amount of the money transfer, the sender, the recipient, special instructions, etc. Such information is utilized for completing the money transfer associated with the request. The request may be transferred from the cable provider to the money transfer provider in an encrypted or secure format in order to protect against fraud and/or theft. In addition, any communications between the set top box and the cable provider may also be encrypted or secured.

Based on receipt of the money transfer request from the cable provider, the money transfer provider may then generate a money transfer control number, or the like associated with the money transfer initiation request (process block 125). In one embodiment, the money transfer control number is a unique identifier which identifies each individual money transfer transaction. The control number may further be used to verify that an individual is the proper recipient of a money transfer.

At process block 130, the money transfer control number may be activated by the user. In one embodiment, the user may activate the control number by calling into a call center for the money transfer provider, provide the control number, and a form of personal identification (e.g., a user ID, an account number, an address, etc.). Alternatively, the user may logon or access a web interface, a satellite system interface, a cable system interface, a PDA, a gaming system, a portable gaming system, etc. to enter the control number and/or personal identification information in order to activate the control number. Furthermore, the user may go to an agent location, an in-lane customer facing device, utilize a mobile device, etc. in order to activate the control number. Once the control number has been activated, the money transfer can be generated.

At process block 135, the money transfer control number may be transmitted to the recipient. In one embodiment, the control number may be transmitted to the recipient by way of the recipient's set top box or similar device. The recipient may receive a message or other notification on their set top box indicating that they have received a new money transfer which includes the control number. Alternatively, the recipient may receive a voice mail message, a text message, an email message, etc. indicating that the recipient has received a money transfer, and including the control number. Furthermore, the recipient may be notified by any of the other devices described above.

Upon receipt of the message and control number, the recipient may then retrieve the money associated with the money transfer. For example, the recipient may go to an agent location, present the control number and proper identification, and be given the money in the amount of the money transfer. Alternatively, the recipient may utilize a web or mobile interface and receive the amount of the money transfer by an electronic funds transfer, or similar mechanism. Furthermore, after successful redemption of the amount of the money transfer by the recipient, the user (the person which initiated the money transfer) may receive notification to that effect. The notification may be sent to the user's set top box, mobile device, telephone, etc.

In an alternative embodiment, instead of generating a money transfer a gaming credit transfer may be generated utilizing the method described above. Such a transfer may be initiated from and/or received at, for example, a consol or portable gaming device (e.g., a Nintendo™ Wii, Microsoft™ Xbox 360, Sony™_Playstation™, Nintendo™ DS, Playstation™ Protable (PSP), Gameboy™, etc.). The gaming credit transfer may be to or from a gaming wallet (or g-wallet) associated with the gaming device. The g-wallet may be used to purchase gaming content, movies, music, and other media, online gaming subscriptions, etc. Alternative to transferring gaming credits, a money transfer may be transferred to or initiated from the gaming device (i.e., within the g-wallet). Accordingly, such a money transfer may be used to purchase gaming credits or may be cashed out (i.e., at an agent location, in-lane, etc.) and used for purposes other than gaming credits. Additionally, money transfers to other wallets such as mobile wallets (or m-wallets) may be made. Such money transfers may be done through a gaming device (consol or portable), a mobile device, or alternatively through a money transfer provider's website (e.g., www.westernunion.com™).

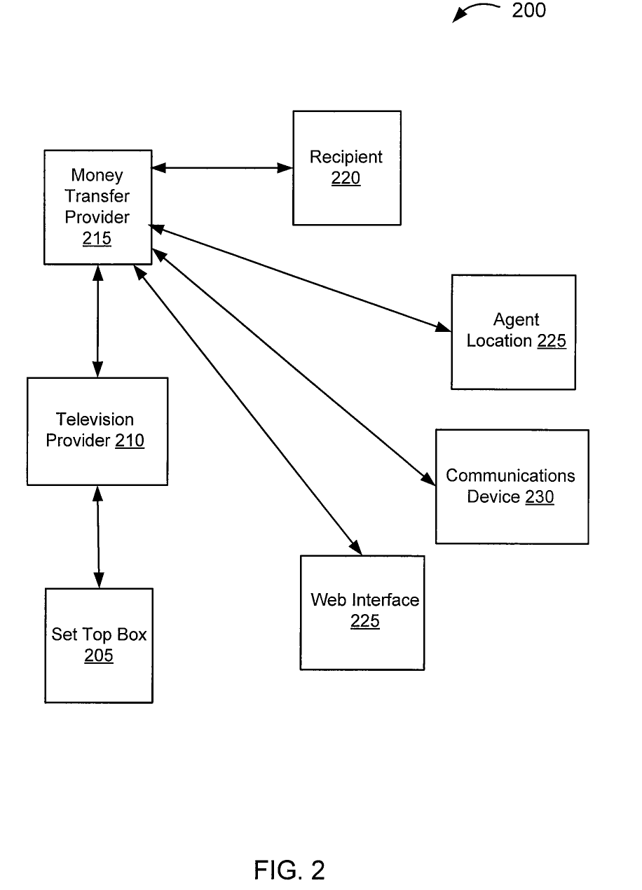

Referring now to FIG. 2, which illustrates a system 200 for providing money transfers executed in connection with cable and/or satellite providers, according to one embodiment of the present invention. In one embodiment, system 200 may include a set top box 205. As discussed above, set top box 205 may alternatively be a DVR system or similar device. Set top box 205 may include an interface which allows a user to select from a money transfer menu of money transfer services offered by a money transfer service provider. The user may utilize their remote control device to select the money transfer service, select a recipient 220 (or recipients), and the amount of the money transfer. Furthermore, the user may use the remote to enter in a PIN number into set top box 205 in order to verify the user's identity.

In a further embodiment, system 200 may include a television provider 210. In one embodiment, television provider 210 may be a cable and/or satellite provider. Television provider 210 may be configured to receive the money transfer requests from set top box 205, and verify the user's identity. For example, television provider 210 may maintain a customer database with each customer's PIN to compare against the entered PIN. If the user's identity can be verified, then television provider 210 would forward the money transfer request to money transfer provider 215.

In one embodiment, money transfer provider 215 may analyze the money transfer request, determine the validity of the request, properly identify the sender and recipient 220, and then generate a money transfer control number associated with the request. After generating the control number, the control number still may need to be activated. Hence, the sender may be sent a message through television provider 210 to set top box 205 indicating that activation of the control number is required before the money transfer can be completed. The message may include instructions as to how to activate the control number.

In one embodiment, the user may activate the control number via a web interface 225, communications device 230, or agent location 225. In one embodiment, web interface 225 may provide the user with a login option to verify the user's identity. Furthermore, communications device 230 may be, for example, a mobile device, a PDA, a cellular device, etc. which allows the user to activate the control number. Upon activation of the control number, money transfer provider 215 may then transmit the control number to recipient 220. Accordingly, recipient 220 may use the control number to retrieve the associated funds from the money transfer.

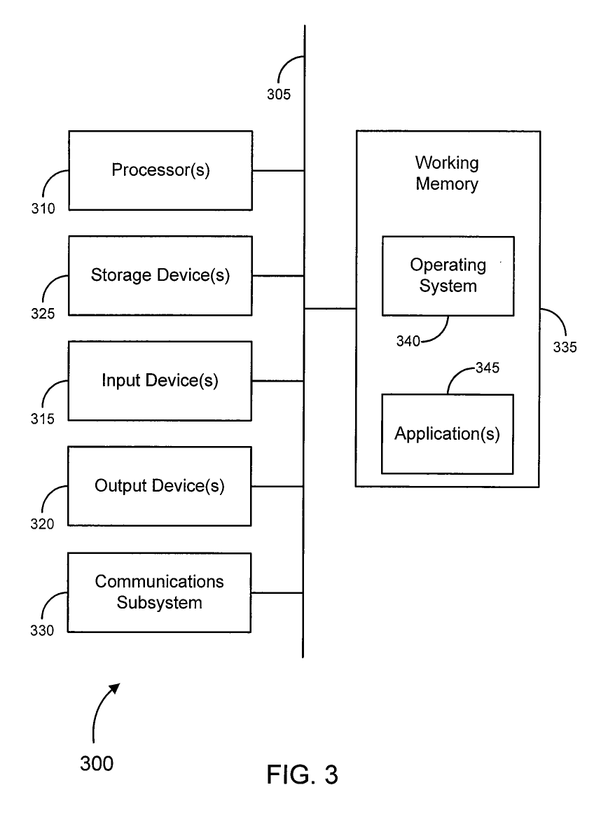

FIG. 3 provides a schematic illustration of one embodiment of a computer system 300 that can perform the methods of the invention, as described herein, and/or can function as, for example, set top box 205 in FIG. 2. It should be noted that FIG. 3 is meant only to provide a generalized illustration of various components, any or all of which may be utilized as appropriate. FIG. 3, therefore, broadly illustrates how individual system elements may be implemented in a relatively separated or relatively more integrated manner.

The computer system 300 is shown comprising hardware elements that can be electrically coupled via a bus 305 (or may otherwise be in communication, as appropriate). The hardware elements can include one or more processors 310, including, without limitation, one or more general-purpose processors and/or one or more special-purpose processors (such as digital signal processing chips, graphics acceleration chips, and/or the like); one or more input devices 315, which can include, without limitation, a mouse, a keyboard and/or the like; and one or more output devices 320, which can include, without limitation, a display device, a printer and/or the like.

The computer system 300 may further include (and/or be in communication with) one or more storage devices 325, which can comprise, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable and/or the like. The computer system 300 might also include a communications subsystem 330, which can include without limitation a modem, a network card (wireless or wired), an infra-red communication device, a wireless communication device and/or chipset (such as a Bluetooth™ device, an 802.11 device, a WiFi device, a WiMax device, cellular communication facilities, etc.), and/or the like. The communications subsystem 330 may permit data to be exchanged with a network (such as the network described below, to name one example), and/or any other devices described herein. In many embodiments, the computer system 300 will further comprise a working memory 335, which can include a RAM or ROM device, as described above.

The computer system 300 can also comprise software elements, shown as being currently located within the working memory 335, including an operating system 340 and/or other code, such as one or more application programs 345, which may comprise computer programs of the invention, and/or may be designed to implement methods of the invention and/or configure systems of the invention, as described herein. Merely by way of example, one or more procedures described with respect to the method(s) discussed above might be implemented as code and/or instructions executable by a computer (and/or a processor within a computer). A set of these instructions and/or code might be stored on a computer readable storage medium, such as the storage device(s) 325 described above. In some cases, the storage medium might be incorporated within a computer system, such as the system 300. In other embodiments, the storage medium might be separate from a computer system (e.g., a removable medium, such as a compact disc, etc.), and or provided in an installation package, such that the storage medium can be used to program a general purpose computer with the instructions/code stored thereon. These instructions might take the form of executable code, which is executable by the computer system 300 and/or might take the form of source and/or installable code, which, upon compilation and/or installation on the computer system 300 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection with other computing devices such as network input/output devices may be employed.

In one aspect, the invention employs a computer system (such as the computer system 300) to perform methods of the invention. According to a set of embodiments, some or all of the procedures of such methods are performed by the computer system 300 in response to processor 310 executing one or more sequences of one or more instructions (which might be incorporated into the operating system 340 and/or other code, such as an application program 345) contained in the working memory 335. Such instructions may be read into the working memory 335 from another machine-readable medium, such as one or more of the storage device(s) 325. Merely by way of example, execution of the sequences of instructions contained in the working memory 335 might cause the processor(s) 310 to perform one or more procedures of the methods described herein.

The terms “machine-readable medium” and “computer readable medium”, as used herein, refer to any medium that participates in providing data that causes a machine to operate in a specific fashion. In an embodiment implemented using the computer system 300, various machine-readable media might be involved in providing instructions/code to processor(s) 310 for execution and/or might be used to store and/or carry such instructions/code (e.g., as signals). In many implementations, a computer readable medium is a physical and/or tangible storage medium. Such a medium may take many forms, including but not limited to, non-volatile media, volatile media, and transmission media. Non-volatile media includes, for example, optical or magnetic disks, such as the storage device(s) 325. Volatile media includes, without limitation, dynamic memory, such as the working memory 335. Transmission media includes coaxial cables, copper wire and fiber optics, including the wires that comprise the bus 305, as well as the various components of the communication subsystem 330 (and/or the media by which the communications subsystem 330 provides communication with other devices). Hence, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, a carrier wave as described hereinafter, or any other medium from which a computer can read instructions and/or code.

Various forms of machine-readable media may be involved in carrying one or more sequences of one or more instructions to the processor(s) 310 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 300. These signals, which might be in the form of electromagnetic signals, acoustic signals, optical signals and/or the like, are all examples of carrier waves on which instructions can be encoded, in accordance with various embodiments of the invention.

The communications subsystem 330 (and/or components thereof) generally will receive the signals, and the bus 305 then might carry the signals (and/or the data, instructions, etc., carried by the signals) to the working memory 335, from which the processor(s) 305 retrieves and executes the instructions. The instructions received by the working memory 335 may optionally be stored on a storage device 325 either before or after execution by the processor(s) 310.

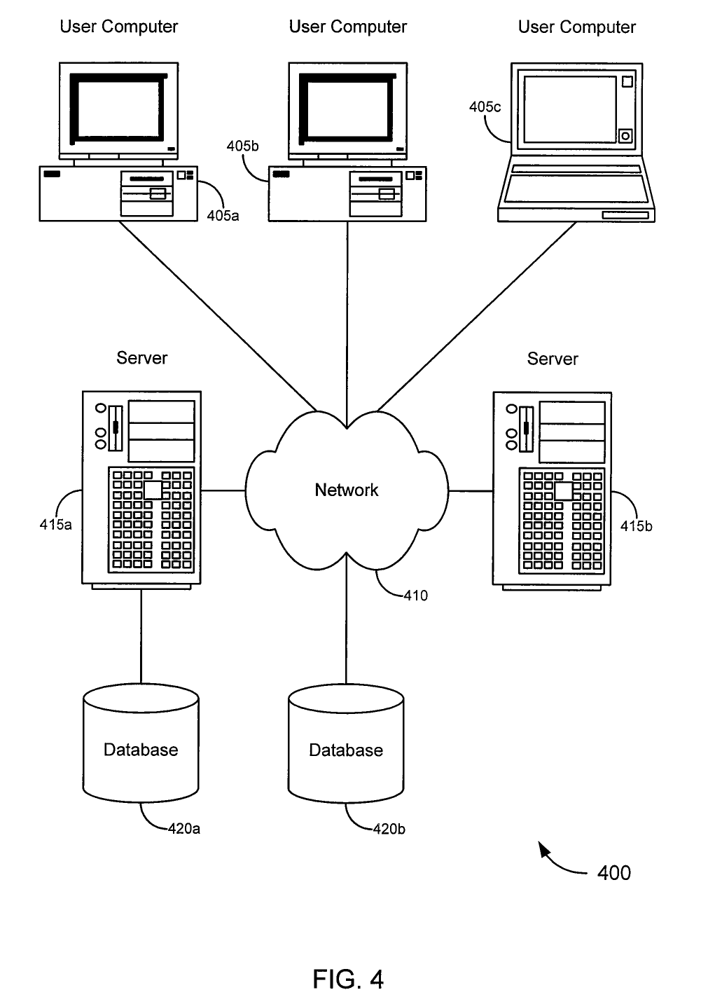

A set of embodiments comprises systems for managing an identity database and generating an identity confidence scoring system. Merely by way of example, FIG. 4 illustrates a schematic diagram of a system 400 that can be used in accordance with one set of embodiments. The system 400 can include one or more user computers 405. The user computers 405 can be general purpose personal computers (including, merely by way of example, personal computers and/or laptop computers running any appropriate flavor of Microsoft Corp.'s Windows™ (e.g., Vista™) and/or Apple Corp.'s Macintosh™ operating systems) and/or workstation computers running any of a variety of commercially-available UNIX™ or UNIX-like operating systems. These user computers 405 can also have any of a variety of applications, including one or more applications configured to perform methods of the invention, as well as one or more office applications, database client and/or server applications, and web browser applications. Alternatively, the user computers 405 can be any other electronic device, such as a thin-client computer, Internet-enabled mobile telephone, and/or personal digital assistant (PDA), capable of communicating via a network (e.g., the network 410 described below) and/or displaying and navigating web pages or other types of electronic documents. Although the exemplary system 400 is shown with three user computers 405, any number of user computers can be supported.

Certain embodiments of the invention operate in a networked environment, which can include a network 410. The network 410 can be any type of network familiar to those skilled in the art that can support data communications using any of a variety of commercially-available protocols, including without limitation TCP/IP, SNA, IPX, AppleTalk, and the like. Merely by way of example, the network 410 can be a local area network (“LAN”), including without limitation an Ethernet network, a Token-Ring network and/or the like; a wide-area network (WAN); a virtual network, including without limitation a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 415. Each of the server computers 415 may be configured with an operating system, including without limitation any of those discussed above, as well as any commercially (or freely) available server operating systems. Each of the servers 415 may also be running one or more applications, which can be configured to provide services to one or more clients 405 and/or other servers 415.

Merely by way of example, one of the servers 415 may be a web server, which can be used, merely by way of example, to process requests for web pages or other electronic documents from user computers 405. The web server can also run a variety of server applications, including HTTP servers, FTP servers, CGI servers, database servers, Java™ servers, and the like. In some embodiments of the invention, the web server may be configured to serve web pages that can be operated within a web browser on one or more of the user computers 405 to perform methods of the invention.

The server computers 415, in some embodiments, might include one or more application servers, which can include one or more applications accessible by a client running on one or more of the client computers 405 and/or other servers 415. Merely by way of example, the server(s) 415 can be one or more general purpose computers capable of executing programs or scripts in response to the user computers 405 and/or other servers 415, including without limitation web applications (which might, in some cases, be configured to perform methods of the invention). Merely by way of example, a web application can be implemented as one or more scripts or programs written in any suitable programming language, such as Java™, C, C#™ or C++, and/or any scripting language, such as Perl, Python, or TCL, as well as combinations of any programming/scripting languages. The application server(s) can also include database servers, including without limitation those commercially available from Oracle™, Microsoft™, Sybase™, IBM™ and the like, which can process requests from clients (including, depending on the configuration, database clients, API clients, web browsers, etc.) running on a user computer 405 and/or another server 415. In some embodiments, an application server can create web pages dynamically for displaying the information in accordance with embodiments of the invention, such as web interface 225 in FIG. 2. Data provided by an application server may be formatted as web pages (comprising HTML, Javascript, etc., for example) and/or may be forwarded to a user computer 405 via a web server (as described above, for example). Similarly, a web server might receive web page requests and/or input data from a user computer 405 and/or forward the web page requests and/or input data to an application server. In some cases, a web server may be integrated with an application server.

In accordance with further embodiments, one or more servers 415 can function as a file server and/or can include one or more of the files (e.g., application code, data files, etc.) necessary to implement methods of the invention incorporated by an application running on a user computer 405 and/or another server 415. Alternatively, as those skilled in the art will appreciate, a file server can include all necessary files, allowing such an application to be invoked remotely by a user computer 405 and/or server 415. It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 420. The location of the database(s) 420 is discretionary: merely by way of example, a database 420a might reside on a storage medium local to (and/or resident in) a server 415a (and/or a user computer 405). Alternatively, a database 420b can be remote from any or all of the computers 405, 415, so long as the database can be in communication (e.g., via the network 410) with one or more of these. In a particular set of embodiments, a database 420 can reside in a storage-area network (“SAN”) familiar to those skilled in the art. (Likewise, any necessary files for performing the functions attributed to the computers 405, 415 can be stored locally on the respective computer and/or remotely, as appropriate.) In one set of embodiments, the database 420 can be a relational database, such as an Oracle™ database, that is adapted to store, update, and retrieve data in response to SQL-formatted commands. The database might be controlled and/or maintained by a database server, as described above, for example.

While the invention has been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods of the invention are not limited to any particular structural and/or functional architecture but instead can be implemented on any suitable hardware, firmware and/or software configuration. Similarly, while various functionality is ascribed to certain system components, unless the context dictates otherwise, this functionality can be distributed among various other system components in accordance with different embodiments of the invention.

Moreover, while the procedures comprised in the methods and processes described herein are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary features, the various components and/or features described herein with respect to a particular embodiment can be substituted, added and/or subtracted from among other described embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A method of providing money transfers executed in connection with cable and/or satellite providers, the method comprising:
presenting an interface to a user on a service provider's signal receiving device, wherein the interface includes money transfer options;
receiving a money transfer initiation request from the user;
verifying the user's identity;
forwarding the money transfer initiation request to a money transfer provider;
generating a money transfer control number associated with the money transfer initiation request;
activating the money transfer control number; and
transmitting the money transfer control number to a recipient.

2. The method of claim 1, wherein the signal receiving device comprises at least one of a set top box, digital video recorder (DVR), a tuner, a satellite radio receiver, a global positioning system (GPS) device, a personal digital assistant (PDA), Bluetooth enabled device, a vehicle interactive display device, and a gaming console.

3. The method of claim 1, wherein the signal receiving device includes an associated remote control device, wherein the remote control device comprises a money transfer initiation selector mechanism.

4. The method of claim 1, wherein the service provider comprises at least on or more of a cable provider, a satellite provider, a satellite radio provider, and a console gaming provider.

5. The method of claim 1, wherein the money transfer initiation request includes an amount of the money transfer, a type of the money transfer, and a recipient of the money transfer.

6. The method of claim 1, wherein the money transfer options comprise presenting the user with a list of recipients to transfer money.

7. The method of claim 1, wherein the money transfer options further comprise:
adding new recipients to the list of recipients; and
removing recipients from the list of recipients.

8. The method of claim 1, wherein the verifying of the user's identity comprises:
receiving an input of a personal identification number (PIN) from the user; and
comparing the PIN to the service provider's records.

9. The method of claim 8, further comprising accessing the service provider's account records for the user in order to verify the user's identity.

10. The method of claim 1, wherein the activation of the control number comprises:
contacting the money transfer provider; and
presenting to the money transfer provider the control number and the recipient.

11. The method of claim 10, wherein the contacting of the money transfer provider is performed using one or more of the following: a web interface, a mobile device, an agent location, and a call center.

12. The method of claim 1, wherein the recipient has a signal receiving device, and the money transfer control number is transferred to the recipient via the recipient's signal receiving device.

13. The method of claim 12, wherein the recipient receives notification of the money transfer via one or more of the following: the recipient's signal receiving device, an email message, a text message, and a voicemail message.

14. The method of claim 1, further comprising transmitting the control number and activation instructions to the user via the signal receiving device.

15. The method of claim 1, further comprising receiving funds from the money transfer from one or more of the following: an agent location, an automated teller machine (ATM), a kiosk, an electronic funds transfer, and an in-lane customer facing device.

16. A system for providing money transfers executed in connection with cable and/or satellite providers, the system comprising:
a set top box configured to present an interface to a user on a service provider's signal receiving device, wherein the interface includes money transfer options, and to receive a money transfer initiation request from the user;
a television provider coupled with the set top box configured to verify the user's identity and to forward the money transfer initiation request to a money transfer provider; and
wherein the money transfer provider coupled with the television provider configured to generate a money transfer control number associated with the money transfer initiation request, to activate the money transfer control number, and to transmit the money transfer control number to a recipient.

17. The system of claim 15, further comprising:
a web interface configured to provide the user with an interface to activate the control number.

18. A machine-readable medium having a set of instructions stored thereon for providing money transfers executed in connection with cable and/or satellite providers which, when executed by a machine, cause the machine to:
present a menu to a user on a service provider's signal receiving device, wherein the interface includes money transfer options;
receive a money transfer initiation request from the user;
verify the user's identity;
forward the money transfer initiation request to a money transfer provider;
generate a money transfer control number associated with the money transfer initiation request;
activate the money transfer control number; and
transmit the money transfer control number to a recipient.

19. The machine-readable medium of claim 18, wherein the signal receiving device comprises at least one of a set top box, digital video recorder (DVR), a tuner, a satellite radio receiver, a global positioning system (GPS) device, a personal digital assistant (PDA), Bluetooth enabled device, a vehicle interactive display device, and a gaming console.

20. The machine-readable medium of claim 18, wherein the service provider comprises at least one or more of a cable provider, a satellite provider, a satellite radio provider, and a console gaming provider.
